(19) United States
(12) Patent Application Publication
(10) Pub. No.: US 2024/0035905 A1
(43) Pub. Date: Feb. 1, 2024

(54) SYSTEM AND METHOD FOR DETECTING AND CLASSIFYING LOADING OF A STRUCTURE USING STRAIN MEASUREMENTS

(71) Applicant: XEROX CORPORATION, Norwalk, CT (US)

(72) Inventors: Tu Hoang, Palo Alto, CA (US); Turki Haj Mohamad, Palo Alto, CA (US); Jin Yan, Palo Alto, CA (US); Ajay Raghavan, Mountain View, CA (US)

(21) Appl. No.: 18/224,766

(22) Filed: Jul. 21, 2023

Related U.S. Application Data
(60) Provisional application No. 63/392,228, filed on Jul. 26, 2022.

(51) Int. Cl. G01L 1/24; G01L 1/26

(52) U.S. Cl. CPC G01L 1/247; G01L 1/246; G01L 1/26

(57) ABSTRACT

A system includes a sensor network comprising a network of optical sensors coupled to structural members of a structure loaded by vehicles or by an environmental event. A processor is operatively coupled to the sensor network. The processor is configured to receive the strain measurements from the network of optical sensors, calculate total strain energy using the received strain measurements, detect a heavy load on the structure in response to the total strain energy exceeding a total strain energy threshold developed for the structure, and determine whether the heavy load results from a superload vehicle or the environmental event. A transmitter is operatively coupled to the processor and configured to transmit one or both of an alert and a condition assessment report for the structure to a predetermined location in response to determining that the heavy load results from the superload vehicle or the environmental event.

RELATED PATENT DOCUMENTS

This application claims the benefit under 35 U.S.C. Section 119 of U.S. Provisional Patent Application Serial No. 63/392,228 entitled SYSTEM AND METHOD FOR DETECTING AND CLASSIFYING LOADING OF A STRUCTURE USING STRAIN MEASUREMENTS filed on Jul. 26, 2022, which is incorporated herein by reference in its entirety.

### TECHNICAL FIELD

This application relates generally to techniques for monitoring structures loaded by vehicles or key events of interest, such as environmental events. The application also relates to components, devices, systems, and methods pertaining to such techniques.

### SUMMARY

Some embodiments of the disclosure are directed to a method comprising receiving strain measurements from a network of optical sensors coupled to a structure loaded by vehicles or by an environmental event. The method also comprises calculating total strain energy using the received strain measurements. The method further comprises detecting a heavy load on the structure in response to the total strain energy exceeding a total strain energy threshold developed for the structure. The method also comprises determining whether the heavy load results from a superload vehicle or the environmental event.

Some embodiments of the disclosure are directed to a system comprising a sensor network which includes a network of optical sensors coupled to structural members of a structure loaded by vehicles or by an environmental event. A processor is operatively coupled to the sensor network. The processor is configured to receive the strain measurements from the network of optical sensors, calculate total strain energy using the received strain measurements, detect a heavy load on the structure in response to the total strain energy exceeding a total strain energy threshold developed for the structure, and determine whether the heavy load results from a superload vehicle or the environmental event. A transmitter is operatively coupled to the processor and configured to transmit one or both of an alert and a condition assessment report for the structure to a predetermined location in response to determining that the heavy load results from the superload vehicle or the environmental event.

### BRIEF DESCRIPTION OF THE DRAWINGS

Throughout the specification reference is made to the appended drawings wherein:

FIG. 1 illustrates a method for monitoring a structure equipped with a network of optical sensors in accordance with various embodiments;

FIG. 2 illustrates a system for monitoring a structure subject to loading by vehicles or key events of interest in accordance with various embodiments;

FIG. 3 illustrates a method for detecting heavy loads on a structure and for classifying special categories of heavy loads, such as superloads, in accordance with various embodiments of the disclosure;

FIG. 4A shows a typical deployment of distributed fiber optic sensors on a bridge in accordance with various embodiments;

FIG. 4B illustrates representative strain data of a detected heavy load event acquired from one of the sensors shown in FIG. 4A;

FIG. 4C shows normalized correlation between detected heavy load events in the form of a correlation matrix in accordance with various embodiments;

FIG. 4D shows the correlation matrix of FIG. 4C and identification of two different types of superloads in accordance with various embodiments;

FIG. 5A shows normalized correlation between detected heavy load events in the form of a correlation matrix in accordance with various embodiments;

FIGS. 5B and 5C shows representative strain signals that are subject to normalized correlation in accordance with various embodiments;

FIG. 5D shows two representative strain signals that have been re-sampled and superimposed on one another in accordance with various embodiments;

FIG. 6A shows a representative correlation matrix in which two types of superload vehicles have been classified based on normalized correlation of event strain signals, shown in 6B and 6C, and ground truth timestamps acquired from a temporary alerting system in accordance with various embodiments;

FIG. 7 illustrates a diagram of a fiber optic monitoring system in accordance with various embodiments described herein; and

FIG. 8 shows a wavelength multiplexed system that can use a compensated sensor array comprising multiple FBG sensors disposed on a single optical fiber in accordance with embodiments described herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Fiber optic (FO) sensors can be used for detecting parameters such as strain, temperature, pressure, current, voltage, chemical composition, and vibration. FO sensors are attractive components because they are thin, lightweight, sensitive, robust to harsh environments, and immune to electromagnetic interference (EMI) and electrostatic discharge. FO sensors can be arranged to simultaneously measure multiple parameters distributed in space with high sensitivity in multiplexed configurations over long optical fiber cables. One example of how this can be achieved is through fiber Bragg grating (FBG) sensors. An FBG sensor is formed by a periodic modulation of the refractive index along a finite length (typically a few mm) of the core of an optical fiber. This pattern reflects a wavelength, called the Bragg wavelength, determined by the periodicity of the refractive index profile. The Bragg wavelength is sensitive to external stimulus (e.g., strain) that changes the periodicity of the grating and/or the index of refraction of the fiber. Thus, FBG sensors rely on the detection of small wavelength changes in response to stimuli of interest.

According to various embodiments, FO sensors can be installed on bridges, wharf structures where large ships (e.g., supertankers) dock, airport runway extension structures where heavily loaded cargo aircraft land, and other structures that are loaded by vehicles or key events of interest. Examples of key events of interest that can load various structures include environmental events such as earthquakes, tsunamis, hurricanes, high surf conditions, and tornados. FO sensors can be operated to detect strain related to loading of structures by vehicles and environmental events.

Embodiments herein may involve hardware of a structure monitoring system based on optical sensors. According to various configurations, the sensors may be FBG strain sensors, Fabry Perot sensors, and/or other interferometric optical sensors. In some cases, the sensors may include one or more of electrical and/or resistive sensors, mechanical sensors, and/or other types of strain gages. In some cases, a combination of different types of sensors may be used.

The sensors described herein are generally described as fibers inscribed with FBG arrays as the sensing element for monitoring loading of a structure (e.g., a bridge, wharf, airport runway extension structure). FBGs are wavelength-specific narrow-band reflectors formed in the core of standard fibers by introducing a periodic variation in the refractive index (RI) of the fiber core. Several factors, including temperature and strain, that change the RI variation will shift the reflection wavelength of an FBG and thus be sensed by the FBG. While embodiments described herein use FBGs as an example, it is to be understood that any suitable types of sensors may be used. Detailed considerations for FBG array design for the specific use case are discussed. The proposed fiber optic-based sensing system has several unique characteristics. For example, the sensing system may be substantially immune to electro-magnetic interference. This allows for less frequent system maintenance and/or calibration, which may be useful for reliable long-term deployment in the field.

The proposed system may be capable of monitoring multiple parameters, including weight-in-motion, speed, axle count, and vehicle class with high accuracy and high dynamic range. For example, the proposed system can be configured to distinguish heavy loads from special case loads, such as superloads.

Superloads are permit-issued vehicles that are overweight and oversized. Although the definition of a superload differs among different jurisdictions, a typical superload is a vehicle or combination with a non-divisible load exceeding sixteen feet wide, sixteen feet high, 125 feet of load length, or 200,000 pounds (e.g., per Washington State DOT). Super loads are required to run at nighttime, and require manual monitoring which is expensive. Because of the potential risk of damage posed by superloads, bridge capacity must be evaluated before and after each traversal by a superload. Superloads on aging bridges can cause serious structural damage if not detected by timely structural integrity assessment.

Accurate detection and tracking of superload movements on an extensive network of bridges is essential for structural health monitoring of bridges and traffic management/planning for construction projects. Embodiments disclosed herein are directed to techniques that provide an insightful superload detection and classification solution. Although embodiments are described generally with respect to superload detection and classification for bridges, it is understood that such detection and classification techniques apply equally to structures that are loaded due to environmental events such as earthquakes and tsunamis.

There are candidates for alternative sensor technology stacks among consumer products for vehicle monitoring, such as magnetic induction loops, piezoelectric sensors, and video analytics. However, these alternatives have intrinsic drawbacks to superload monitoring. For example, induction loops are sensitive to electromagnetic interference, and piezoelectric sensors are limited to short-distance transmission. On the other hand, video-based systems, while being an unintrusive method which in some cases is the only permitted solution, require extensive data storage and transfer solutions. Moreover, these limitations are worsened in cases of large and slow-moving vehicles such as superloads.

Embodiments of the disclosure are directed to the use of distributed fiber optic sensors attached to a structure, such as a bridge or a wharf. Such embodiments are capable of robustly and accurately detecting heavy loads, and distinguishing heavy loads from special case loads (e.g., superloads, loads due to environmental events). In the context of bridge monitoring, various embodiments utilize distributed fiber optic sensors instrumented on bridges and a temporary alerting system (e.g., GPS tracking and geofence alert) for heavy load detection and classification results.

Embodiments provide improvement over conventional monitoring approaches by providing vehicle detection and monitoring using an array of optical strain sensors. Vehicle detection can be refined by using feedback processing, taking bridge skewness into consideration. Data fusion of speed estimation and ground truth strain patterns provides for enhanced superload classification. Embodiments can provide an asset owner with a structural integrity evaluation report for permitted superloads.

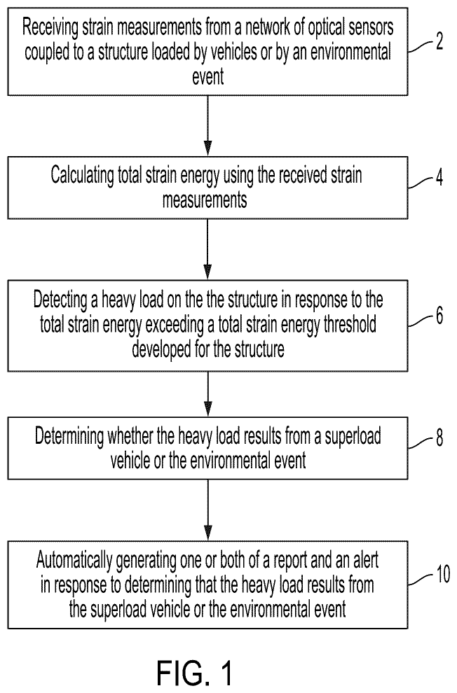

FIG. 1 illustrates a method for monitoring a structure equipped with a network of optical sensors in accordance with various embodiments. The method shown in FIG. 1 involves receiving 2 strain measurements from a network of optical sensors coupled to a structure loaded by vehicles or by an environmental event (e.g., an earthquake). The method involves calculating 4 total strain energy using the received strain measurements. The method also involves detecting 6 a heavy load on the structure in response to the total strain energy exceeding a total strain energy threshold developed for the structure. The method further involves determining 8 whether the heavy load results from a superload vehicle or the environmental event. The method can also involve automatically generating 10 one or both of a report and an alert in response to determining that the heavy load results from the superload vehicle or the environmental event.

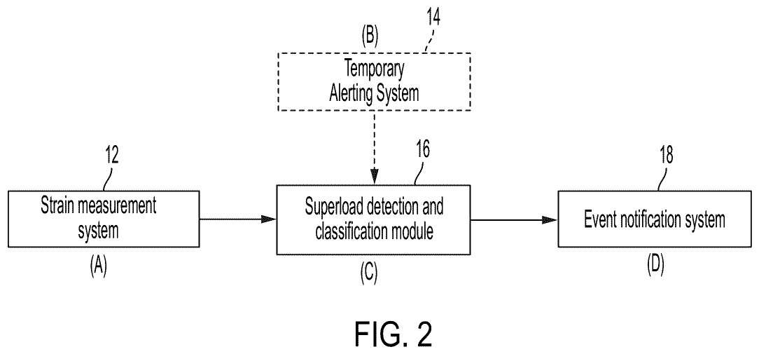

According to some embodiments, and with reference to FIG. 2, a system for monitoring a structure subject to loading by vehicles includes a strain measurement system 12, a temporary alerting system 14, a superload detection and classification module 16, and an event notification system 18. The strain measurements system 12 includes distributed strain sensors, such as fiber-optic sensors, configured to continuously measure the strain response of the structure (e.g., structural members such as beams and girders) under loads.

The temporary alerting system 14 (e.g., GPS instrumented vehicles, camera) can be configured to track superload vehicles and trigger an alert in response to detecting an incoming superload vehicle. The temporary alerting system 14 is used to provide timestamps for ground truth superload events, which are later used to classify vehicle class and separate superloads from overload/oversized vehicles. As such, the temporary alerting system 14 can be disabled once sufficient data is collected. For example, sufficiency can be defined as three event timestamps collected for each class of superload vehicles. It is noted that the temporary alerting system 14 can provide various forms ground truth data, including one or more of camera data, GPS data acquired from GPS instrumented vehicles, seismometer data, and weather data for extreme weather events, for example.

The super load detection and classification module 16 is configured to use the total strain energy calculated using received strain measurements to detect heavy loads and classify them into superloads using the ground truth timestamps from the temporary alerting system 14. The superload detection and classification module 16 operates continuously, analyzing strain data as measured. The event notification system 18 is configured to automatically generate one or both of reports and alerts. For example, the event notification system 18 can be configured to generate structural response and/or conditions reports using the extracted data with accurate timestamps. Superload vehicle detection and classification provides for enhanced insight into how the structure reacts to the same loading condition for better comparison and assessment.

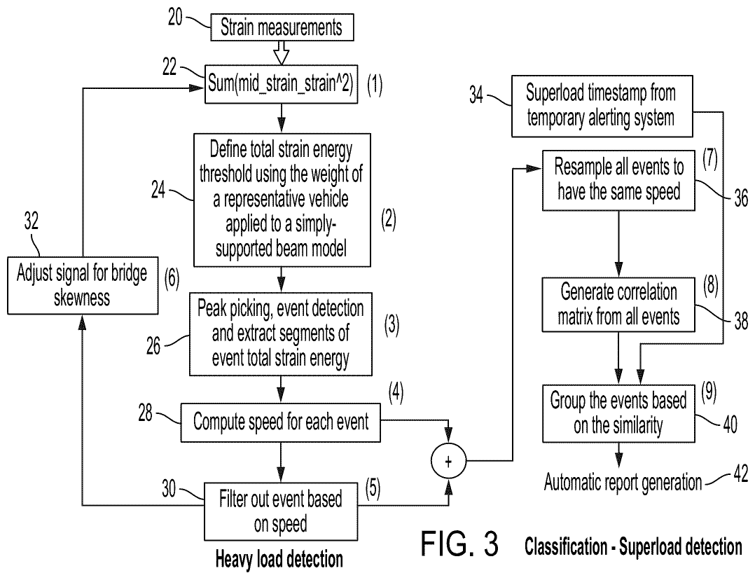

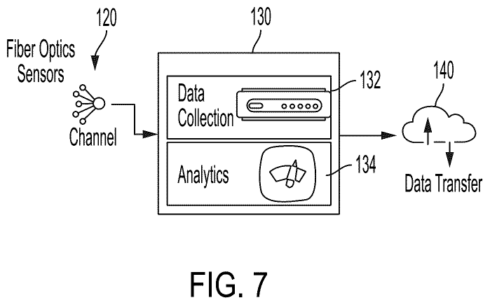

FIG. 3 illustrates a method for detecting heavy loads on a structure and for classifying special categories of heavy loads, such as superloads, in accordance with embodiments of the disclosure. The processes shown in FIG. 3 and other figures can be implemented by the system shown in FIG. 7 (discussed below, which includes a processor 130, a data collection module 132, an analytics module 134, and a transmitter 140). The following discussion is directed to heavy load detection and classification for vehicles traversing a bridge. It is understood that the processes shown in FIG. 3 can be applied to any structure which is subject to loading by vehicles or key events of interest, such as environmental events, as previously discussed.

Heavy load detection includes processes 20-32 shown in FIG. 3. Heavy load classification (e.g., superload detection) includes processes 34-42 shown in FIG. 3. Heavy load detection involves the acquisition 20 of strain measurements from optical sensors deployed on the structure (e.g., a bridge). Strain measurements acquired from a key load supporting member of the structure are summed 22 and used to calculate the total strain energy at the key load supporting member. In the case of a bridge, the key load supporting member can be a mid-span support member (beam, girder), which correlates with a heavy vehicle's axle configuration. This step operates continuously on the strain data 20.

A threshold of the total strain energy can be established 24 for the structure (e.g., bridge). For example, the total strain energy threshold can be developed using weight, equivalent force, or a boundary condition of a representative heavy load applied to a reduced-order physics-based model of the structure, such as a simply-supported beam model. Any load that produces a total energy strain higher than this threshold is classified as an event of a heavy load.

The total strain energy's time-history data is used to detect 26 the event, using the total strain energy threshold. The center timestamp of the detected event is selected as the event timestamp. For each detected heavy load event, a segment of the whole event is extracted. The start and end timestamps can be determined using the total strain energy threshold at 10% of the event peak total strain energy.

The vehicle's speed can be estimated 28 using the known longitudinal distance between two measurement locations. In some implementations, the vehicle's speed can be estimated using the known longitudinal distance between two measurement locations and a lag (in time unit) of the correlation of the total strain energy of all sensors at the same longitudinal locations. Therefore, it is preferable to select the two measurement locations with the farthest distance from each other.

After the speed estimation is obtained, it can be used as a parameter to filter 30 the relevant events as the heavy load vehicles have a low-speed limitation. For example, the estimated speed can be used to filter out events having a speed which is beyond an expected or known speed threshold. The value for the speed threshold can be obtained from the superload operator/local traffic rules, for example. It is noted that the speed threshold value should be used as a reference instead of a hard threshold due to uncertainty in speed estimation and driver behavior when controlling the vehicle.

In the special case of a highly skewed structure (e.g., bridge), the total strain energy calculation at the key load supporting member (e.g., mid-span beam or girder) may need to be adjusted 32, as the peak strain values of the mid-span sensors are not aligned. Estimated speed and lateral distance between sensors in the same longitudinal locations can be used to calculate the time delay. The delay in time can be converted to delay in samples depending on the sampling frequency to align the data more accurately.

At the conclusion of the heavy load detection process (steps 20-32), strain, timestamps, and speeds of heavy vehicles crossing the structure (e.g., bridge) are extracted. The method shown in FIG. 3 continues with heavy load classification processes 34-42.

It is noted that the heavy vehicle detection system detects not only superload vehicles but also other overloaded and oversized vehicles. The is an inherent drawback due to use of a single source of information (strain signals). Because superload vehicles have distinct axle configurations manifested on the strain signal, further classification can be performed to group the vehicles into clusters, of which superload and oversized/overloaded vehicles are separated. Initially, using the temporary alerting system, timestamps are determined for known superload events and utilized as the ground truth for the superload group.

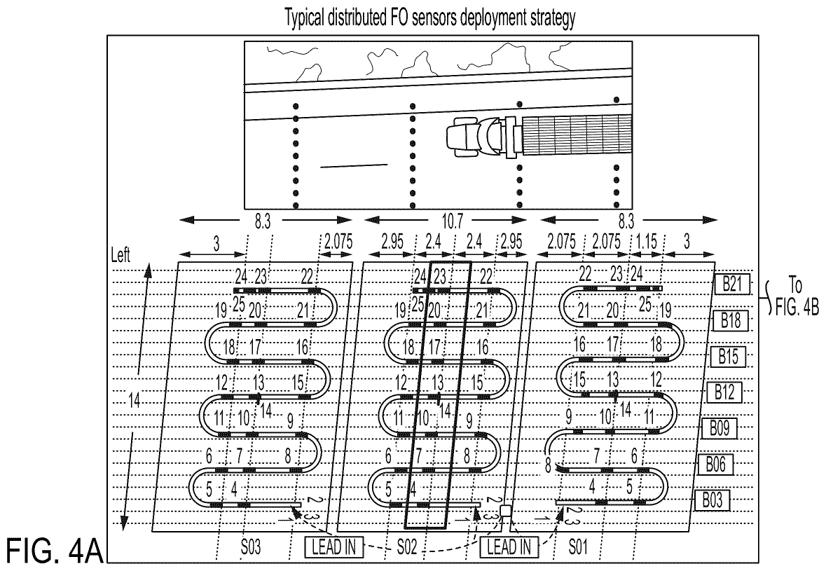

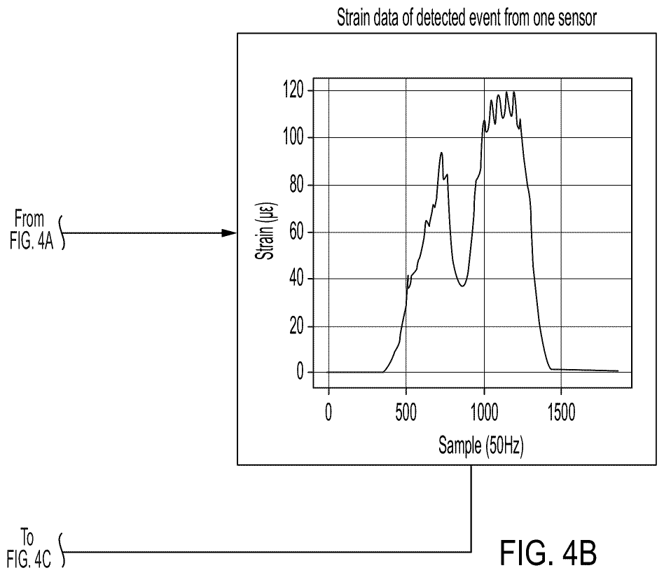

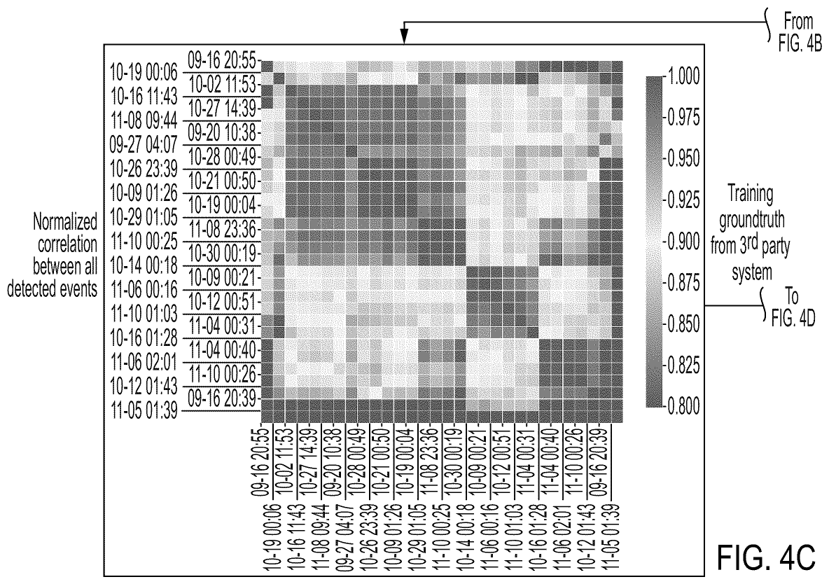

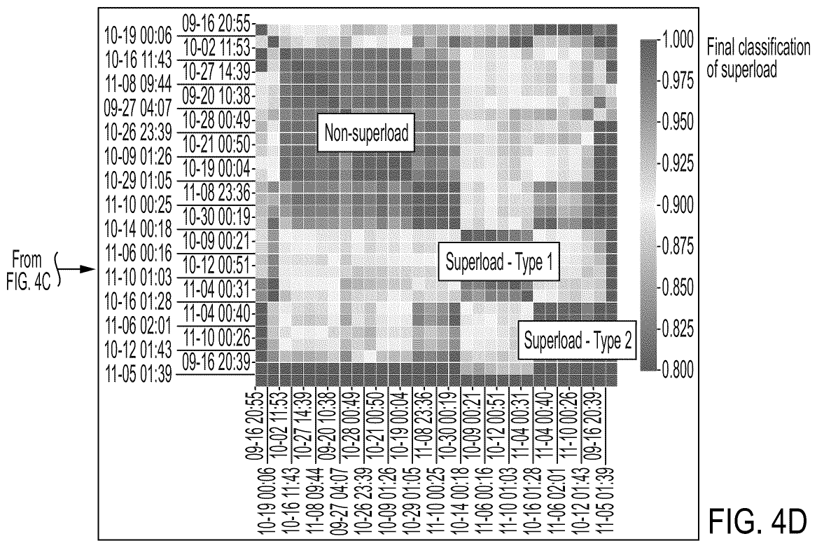

With continued reference to FIG. 3 and with reference to FIGS. 4A-4D, FIG. 4A shows a typical deployment of distributed fiber optic sensors on a bridge. In this illustrative example, three fibers each having 25 optical sensors are deployed on support members (beams, girders) of the bridge. The center fiber is deployed on a mid-span support member of the bridge. FIG. 4B illustrates representative strain data of a detected heavy load event from one of the sensors shown in FIG. 4A. FIG. 4C shows normalized correlation between detected heavy load events in the form of a correlation matrix. FIG. 4D shows the correlation matrix of FIG. 4C and classification of two different types of superloads.

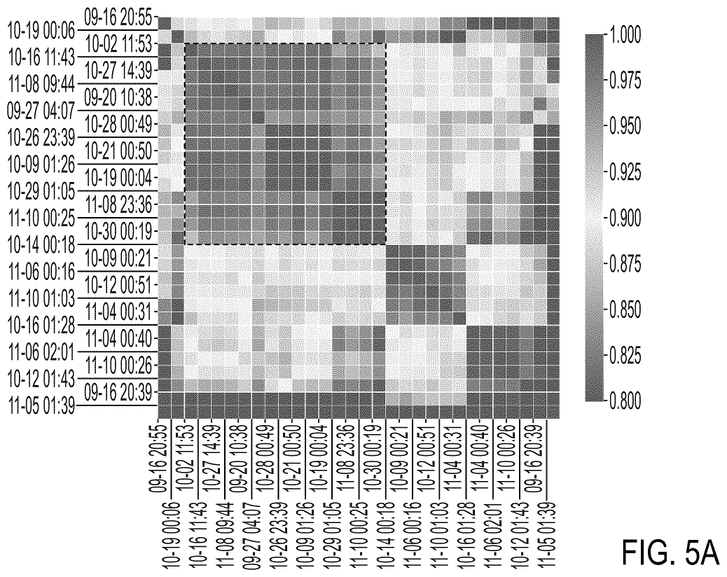

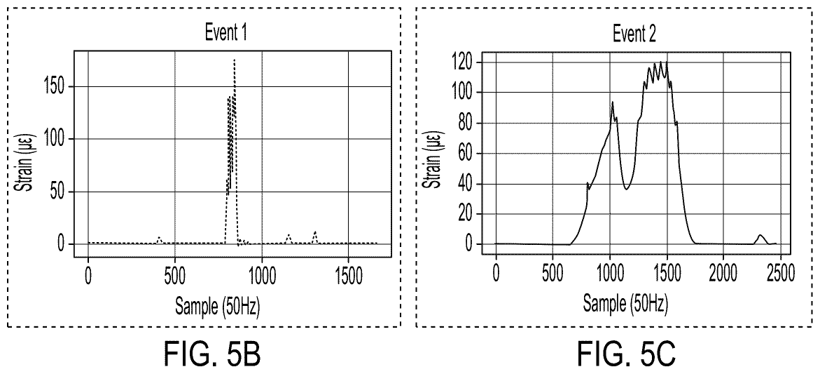

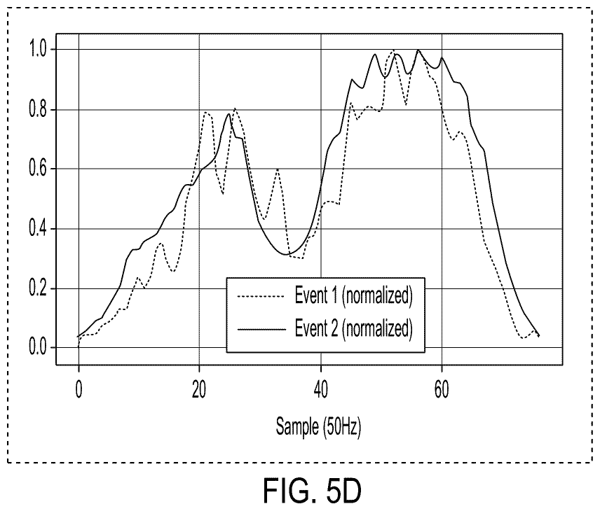

With continued reference to FIG. 3 and to FIGS. 5A-5D, all detected event strain signals are re-sampled 36 to have the same amplitude and speed as the lowest detected speed. Visually, the objective of this step is to effectively “stretch” all events to the same speed and amplitude. This makes the process of comparing detected strain signals more efficient. For example, consider the strain signals from two different heavy load events shown in Figures 5B and 5C. FIG. 5D shows these two strain signals that have been re-sampled and superimposed on one another. Normalized correlation between all events is then calculated 38. This step produces an N×N correlation matrix (see FIGS. 4C and 5A), where N is the number of detected heavy load events.

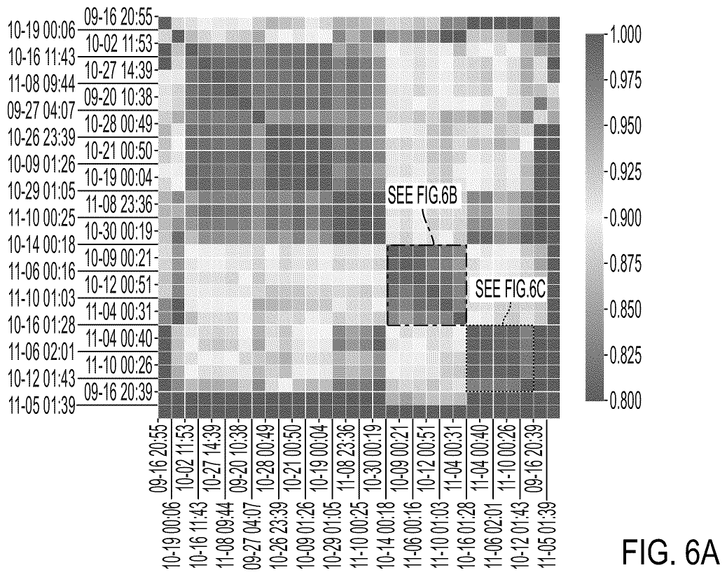

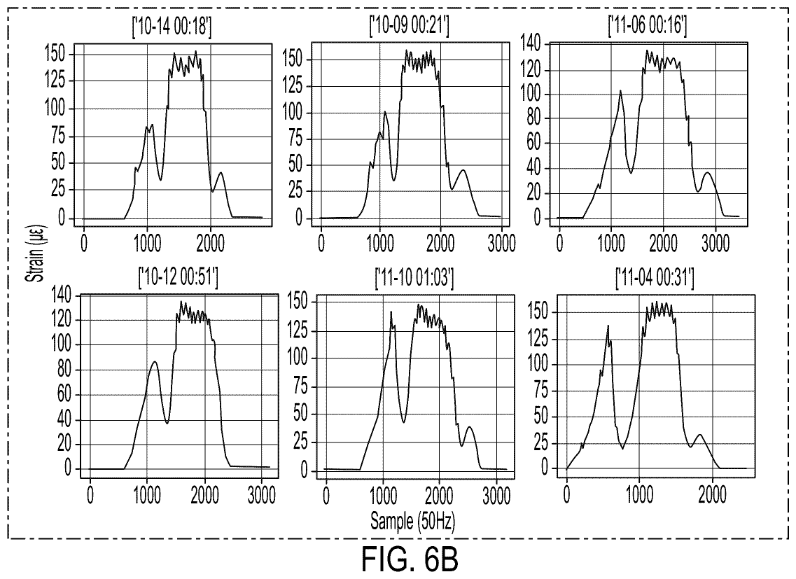

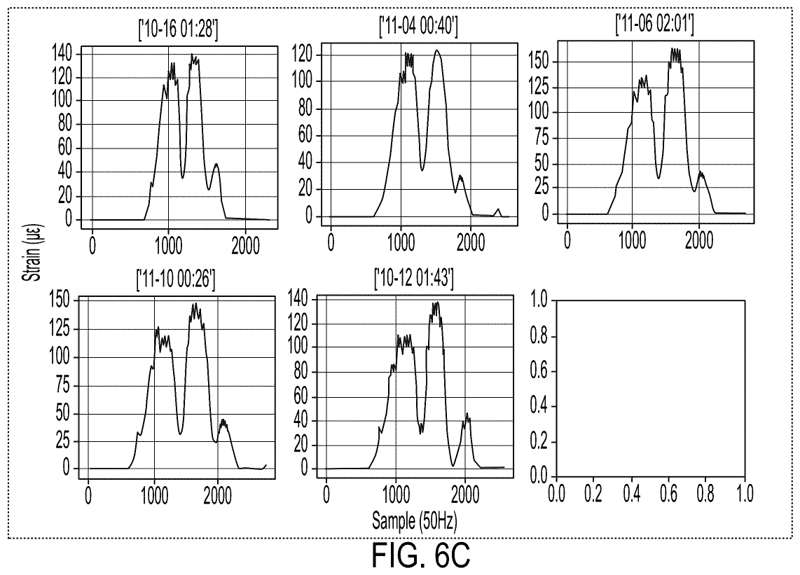

Strain data of representative superload events extracted using the temporary alerting system timestamps 34 are used as the ground truth. Detected heavy load events highly correlated with the ground truth strain signatures are classified into the superload class or classes. For example, FIG. 6A shows a representative correlation matrix in which two types of superload vehicles have been classified based on normalized correlation of event strain signals (see FIGS. 6B and 6C) and ground truth timestamps acquired from the temporary alerting system. In this illustrative example, two classes of superload vehicles have been identified by the system. Further classifications of superload vehicles, inferring a specific project, vehicle owner, or axle group configuration, can also be performed. It is noted that unrelated groups of oversize and overload vehicles with low correlation can be filtered out. Lastly, one or both of automatic report and alert generation 42 can be implemented in response to detecting one or more classes of superload vehicles.

As discussed above, various embodiments involve installation strategies to incorporate fibers onto structural members (e.g., beams, girders) of a structure, such as a bridge. Embodiments described herein involve fibers with an inscribed FBG array which are deployed on a structure to sense loading due to vehicles and/or key events of interest (e.g., environmental events). FIG. 7 illustrates a diagram of a fiber optic structure monitoring system in accordance with embodiments described herein.

Fiber optic sensors 120 are deployed on a structure which is subject to loading by vehicles and environmental events. Vehicles and environmental events that load the structure induce structure deformation, which may cause strain on the sensors 120 and produce an FBG wavelength shift signal. The fiber optic sensors 120 are connected to an FBG interrogator at one end, where the center wavelength of each FBG on the fiber is tracked at a desired frequency. The center wavelengths of FBGs can be streamed to a processor 130 having a data collection module 132 and an analytics module 134. The analytics module 134 can be configured to perform the processes illustrated in FIGS. 1 and 3. The extracted information can then be transferred to a predetermined location via a transmitter 140. For example, the extracted information may be transferred to the cloud, enabling a remote-control center to use the information. In some implementations, information translation can occur after the raw sensing data are transferred to the cloud.

Typically, there are multiple FBG sensors on one fiber. The center wavelength of each FBG's reflection band distributes in a certain wavelength range. For example, the wavelength range can be from 1510 nm-1590 nm. In one embodiment, the reflection wavelength of each FBG on the same fiber has certain spacing in the spectrum. For example, the spectral spacing of FBGs on the same fiber can be ˜2-3 nm. In the wavelength range 1510-1590 nm, a 3 nm spacing will allow ˜26 FBGs on one fiber to be interrogated simultaneously. In another implementation, FBGs on the same fiber can have overlapped reflection bands and signals from different FBGs are distinguished by additional time domain features (e.g., reflection time). In general, the sensing fiber design for this application needs to consider the level of multiplexing needed and trade-offs between system performance (sampling rate, wavelength accuracy, etc.) and overall cost (hardware, installation, maintenance, etc.)

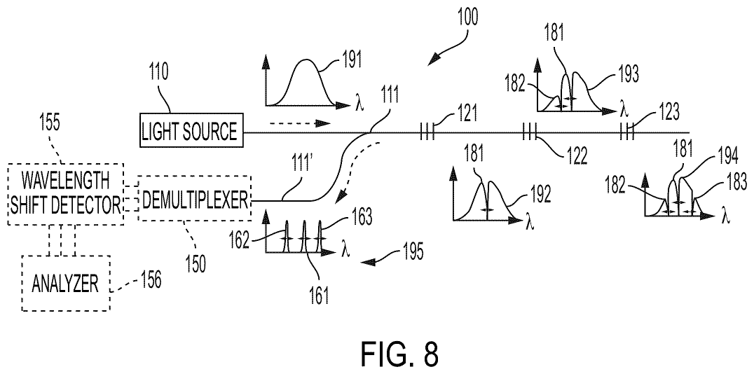

FO sensors can simultaneously measure multiple parameters distributed in space with high sensitivity in multiplexed configurations over long FO cables. One example of how this can be achieved is through FBG sensors. FIG. 8 shows a wavelength multiplexed system 100 can use a compensated sensor array comprising multiple FBG sensors 121, 122, 123 disposed on a single optical fiber 111. The sensors 121 — 123 may be arranged to sense parameters including one or more of temperature, strain, and/or vibration, for example. As indicated in FIG. 8, input light is provided by the light source 110, which may comprise or be a light emitting diode (LED) or superluminescent laser diode (SLD), for example. The spectral characteristic (intensity vs. wavelength) of broadband light is shown by inset graph 191. The intensity is highest near the middle of the spectrum and falls off at the spectrum edges. The sensors 121, 122, 123 include compensation, e.g., one or more of different reflectivities and different attenuations, that decreases the difference in the intensity of the output signal light reflected by the sensors to compensate for the input light that is non-uniform in intensity, e.g., due to spectral non-uniformity of the light source and/or scattering losses in the optical fiber. The input light is transmitted via the optical fiber (FO) cable 111 to the first FBG sensor 121. The first FBG sensor 121 reflects a portion of the light in a first wavelength band having a central wavelength, λ1. Light having wavelengths other than within the first wavelength band is transmitted through the first FBG sensor 121 to the second FBG sensor 122. The spectral characteristic of the light transmitted to the second FBG sensor 122 is shown in inset graph 192 and exhibits a notch 181 at the first wavelength band centered at λ1 indicating that light in this wavelength band is reflected by the first sensor 121.

The second FBG sensor 122 reflects a portion of the light in a second wavelength band having a central wavelength, λ2. Light that is not reflected by the second FBG sensor 122 is transmitted through the second FBG sensor 122 to the third FBG sensor 123. The spectral characteristic of the light transmitted to the third FBG sensor 123 is shown in inset graph 193 and includes notches 181, 182 centered at λ1 and λ2.

The third FBG sensor 123 reflects a portion of the light in a third wavelength band having a central or peak wavelength, λ3. Light that is not reflected by the third FBG sensor 123 is transmitted through the third FBG sensor 123. The spectral characteristic of the light transmitted through the third FBG sensor 123 is shown in inset graph 194 and includes notches 181, 182, 183 centered at λ1, λ2, and λ3.

Light in wavelength bands 161, 162, 163, having central wavelengths k1, k2 and k3 (illustrated in inset graph 195) is reflected by the first, second, or third FBG sensors 121, 122, 123, respectively, along the FO cables 111 and 111′ to an the optical wavelength demultiplexer 150. Compensating input characteristics of sensors 121, 122, 123 cause the difference in the intensity peaks of the light 161, 162, 163 to be reduced when compared to the intensity peaks from an uncompensated sensor array.

From the wavelength demultiplexer 150, the sensor light 161, 162, 163 may be routed to a wavelength shift detector 155 that generates an electrical signal responsive to shifts in the central wavelengths k1, k2 and k3 and/or wavelength bands of the sensor light. The wavelength shift detector 155 receives reflected light from each of the sensors and generates corresponding electrical signals in response to the shifts in the central wavelengths λ1, λ2 and k3 or wavelength bands of the light reflected by the sensors 121-123. The analyzer 156 may compare the shifts to a characteristic base wavelength (a known wavelength) to determine whether changes in the values of the parameters sensed by the sensors 121-123 have occurred. The analyzer 156 may determine that the values of one or more of the sensed parameters (e.g., strain) have changed based on the wavelength shift analysis and may calculate a relative or absolute measurement of the change.

In some cases, instead of emitting broadband light, the light source may scan through a wavelength range, emitting light in narrow wavelength bands to which the various sensors disposed on the FO cable are sensitive. The reflected light is sensed during a number of sensing periods that are timed relative to the emission of the narrowband light. For example, consider the scenario where sensors 1, 2, and 3 are disposed on a FO cable. Sensor 1 is sensitive to a wavelength band WB1, sensor 2 is sensitive to wavelength band WB2, and sensor 3 is sensitive to WB3. The light source may be controlled to emit light having WB1 during time period 1 and sense reflected light during time period la that overlaps time period 1. Following time period la, the light source may emit light having wavelength band WB2 during time period 2 and sense reflected light during time period 2a that overlaps time period 2. Following time period 2a, the light source may emit light having wavelength band WB3 during time period 3 and sense reflected light during time period 3a that overlaps time period 3. Using this version of time domain multiplexing, each of the sensors may be interrogated during discrete time periods. When the intensity of the narrowband light sources varies, a compensated sensor array as discussed herein may be useful to compensate for the intensity variation of the sources.

The FO cable may comprise a single mode (SM) FO cable or may comprise a multi-mode (MM) FO cable. While single mode fiber optic cables offer signals that are easier to interpret, to achieve broader applicability and lower costs of fabrication, multi-mode fibers may be used. MM fibers may be made of plastic rather than silica, which is typically used for SM fibers. Plastic fibers may have smaller turn radii when compared with the turn radii of silica fibers. This can offer the possibility of curved or flexible configurations, for example. Furthermore, MM fibers can work with less expensive light sources (e.g., LEDs) as opposed to SM fibers that may need more precise alignment with superluminescent diodes (SLDs). Therefore, sensing systems based on optical sensors in MM fibers may yield lower cost systems.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The various embodiments described above may be implemented using circuitry and/or software modules that interact to provide particular results. One of skill in the computing arts can readily implement such described functionality, either at a modular level or as a whole, using knowledge generally known in the art. For example, the flowcharts illustrated herein may be used to create computer-readable instructions/code for execution by a processor. Such instructions may be stored on a computer-readable medium and transferred to the processor for execution as is known in the art.

The foregoing description of the example embodiments have been presented for the purposes of illustration and description. It is not intended to be exhaustive or to limit the inventive concepts to the precise form disclosed. Many modifications and variations are possible in light of the above teachings. Any or all features of the disclosed embodiments can be applied individually or in any combination, not meant to be limiting but purely illustrative. It is intended that the scope be limited by the claims appended herein and not with the detailed description.

What is claimed is:

1. A method, comprising:
receiving strain measurements from a network of optical sensors coupled to a structure loaded by vehicles or by an environmental event;
calculating total strain energy using the received strain measurements;
detecting a heavy load on the structure in response to the total strain energy exceeding a total strain energy threshold developed for the structure; and
determining whether the heavy load results from a superload vehicle or the environmental event.

2. The method of claim 1, comprising automatically generating one or both of a report and an alert in response to determining that the heavy load results from the superload vehicle or the environmental event.

3. The method of claim 2, wherein the report comprises a condition assessment of the structure.

4. The method of claim 1, comprising:
summing the strain measurements acquired from a key load supporting member of the structure; and
calculating the total strain energy using the summed strain measurements acquired from the key load supporting member.

5. The method of claim 4, comprising adjusting the total strain energy calculated for the key load supporting member based on a skew angle of the structure.

6. The method of claim 1, wherein the total strain energy threshold is developed using weight, equivalent force, or a boundary condition of a representative heavy load applied to a reduced-order physics-based model of the structure.

7. The method of claim 1, wherein:
detecting the heavy load vehicle comprises picking a peak of the total strain energy; and
comparing the peak of the total strain energy to the total strain energy threshold.

8. The method of claim 1, comprising:
computing the speed of each event of heavy load vehicle detection; and
filtering out events having a speed which is beyond an expected or known speed threshold.

9. The method of claim 1, wherein determining whether the heavy load results from the superload vehicle or the environmental event comprises:
computing the speed of each event of heavy load detection;
resampling strain profiles for all events to have the same speed and amplitude;
calculating normalized correlation between the resampled strain profiles to produce an N×N correlation matrix, where N is a number of the detected events; and
classifying resampled strain profiles of the correlation matrix as corresponding to superload vehicles, environmental events, non-superload vehicles, and non-environmental events.

10. The method of claim 9, wherein classifying resampled strain profiles of the correlation matrix is based on ground truth data.

11. The method of claim 10, wherein the ground truth data comprises one or more of camera data, GPS data acquired from GPS instrumented vehicles, seismometer data, and weather data for extreme weather events.

12. A system, comprising:
a sensor network comprising a network of optical sensors coupled to structural members of a structure loaded by vehicles or by an environmental event;
a processor operatively coupled to the sensor network and configured to:
receive the strain measurements from the network of optical sensors;
calculate total strain energy using the received strain measurements;
detect a heavy load on the structure in response to the total strain energy exceeding a total strain energy threshold developed for the structure; and
determine whether the heavy load results from a superload vehicle or the environmental event; and
a transmitter operatively coupled to the processor and configured to transmit one or both of an alert and a condition assessment report for the structure to a predetermined location in response to determining that the heavy load results from the superload vehicle or the environmental event.

13. The system of claim 12, wherein the processor is configured to automatically generate one or both of the report and the alert in response to determining that the heavy load results from the superload vehicle or the environmental event.

14. The system of claim 13, wherein the report comprises a condition assessment of the structure.

15. The system of claim 12, wherein the processor is configured to:
sum the strain measurements acquired from a key load supporting member of the structure; and
calculate the total strain energy using the summed strain measurements acquired from the key load supporting member.

16. The system of claim 15, wherein the processor is configured to adjust the total strain energy calculated for the key load supporting member based on a skew angle of the structure.

17. The system of claim 12, wherein the total strain energy threshold is developed using weight, equivalent force, or a boundary condition of a representative heavy load applied to a reduced-order physics-based model of the structure.

18. The system of claim 12, wherein the processor is configured to:
detect the heavy load vehicle by picking a peak of the total strain energy; and
compare the peak of the total strain energy to the total strain energy threshold.

19. The system of claim 12, wherein the processor is configured to:
compute the speed of each event of heavy load vehicle detection; and
filter out events having a speed which is beyond an expected or known speed threshold.

20. The system of claim 12, wherein the processor is configured to determine whether the heavy load results from the superload vehicle or the environmental event by:
computing the speed of each event of heavy load detection;
resampling strain profiles for all events to have the same speed and amplitude;
calculating normalized correlation between the resampled strain profiles to produce an N×N correlation matrix, where N is a number of the detected events; and
classifying resampled strain profiles of the correlation matrix as corresponding to superload vehicles, environmental events, non-superload vehicles, and non-environmental events.

21. The system of claim 20, wherein the processor is configured to classify resampled strain profiles of the correlation matrix based on ground truth data.

22. The system of claim 21, wherein the ground truth data comprises one or more of camera data, GPS data acquired from GPS instrumented vehicles, seismometer data, and weather data for extreme weather events.
